(19) United States
(12) Patent Application Publication
(10) Pub. No.: US 2007/0022134 A1
(43) Pub. Date: Jan. 25, 2007

(54) Cross-language related keyword suggestion

(75) Inventors: Ming Zhou, Beijing (CN); Hua-Jun Zeng, Beijing (CN); Zheng Chen, Beijing (CN); Yajuan Lv, Beijing (CN); Benyu Zhang, Beijing (CN); Ying Li, Bellevue, WA (US); Li Li, Issaquah, WA (US); Jeffrey Hartin, Carnation, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/187,289

(22) Filed: Jul. 22, 2005

(51) Int. Cl. G06F 7/00

(52) U.S. Cl. 707/102

(57) ABSTRACT

Identifying and selecting keywords in a second language based on an input keyword from a user in a first language. Translation candidates in the second language are determined from the input keyword. Keywords in the second language related to the translation candidates are identified and included with the translation candidates. The translation candidates are ranked and presented to the user for selection.

### BACKGROUND

A keyword or phrase is a word or set of terms submitted by a user to a search engine when searching for a related web page/site on the World Wide Web. Search engines determine the relevancy of a web site based on the keywords and keyword phrases that appear on the page/site. Because a significant percentage of web site traffic results from use of search engines, proper keyword/phrase selection is vital to increasing site traffic to obtain desired site exposure. In general, promoters (e.g., advertisers) try to identify and select as many keywords as possible to increase site traffic. Techniques to identify keywords relevant to a web site for search engine result optimization include, for example, evaluation by a human being of web site content and purpose to identify relevant keyword(s). This evaluation may include the use of a keyword popularity tool. Such tools determine how many people submitted a particular keyword or phrase including the keyword to a search engine. Keywords relevant to the web site and determined to be used more often in generating search queries are generally selected for search engine result optimization with respect to the web site. Another typical technique for identifying keywords includes a computerized keyword suggestion tool that provides a list of keywords related to an input keyword. For example, the input keyword “car” may yield “car accessories,” “luxury cars,” etc. Each keyword identified by such a system is typically in the same language as the input keyword.

After identifying and selecting a set of keywords for search engine result optimization of the web site, a promoter may desire to advance a web site to a higher position in the search engine's results (e.g., as compared to displayed positions of other web site search engine results). To this end, the promoter bids on the keyword(s) to indicate how much the promoter will pay each time a user clicks on the promoter's listings associated with the keyword(s). In other words, keyword bids are pay-per-click bids. The larger the amount of the keyword bid as compared to other bids for the same keyword, the higher (e.g., more prominently with respect to significance) the search engine will display the associated web site in search results based on the keyword.

### SUMMARY

Embodiments of the invention provide multilingual keyword identification and selection. In response to an input keyword in one language from a user, one or more related keywords (e.g., translation candidates) in another language are identified. In one embodiment, the invention generates a list of the translation candidates as a function of the input keyword by applying morphological changes to the input keyword, translating the input keyword, and transliterating the input keyword. The translation candidates are presented and validated to the user for review and selection. The input keyword may relate to, for example, goods and/or services.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating one example of a suitable operating environment in which aspects of the invention may be implemented.

FIG. 2 is an exemplary flow chart illustrating operation of the components illustrated in FIG. 1.

FIG. 3 is an exemplary flow chart illustrating cross-language related keyword suggestion with French as the original language and English as the target language.

FIG. 4 is an exemplary flow chart illustrating keyword transliteration and validation.

Corresponding reference characters indicate corresponding parts throughout the drawings.

### DETAILED DESCRIPTION

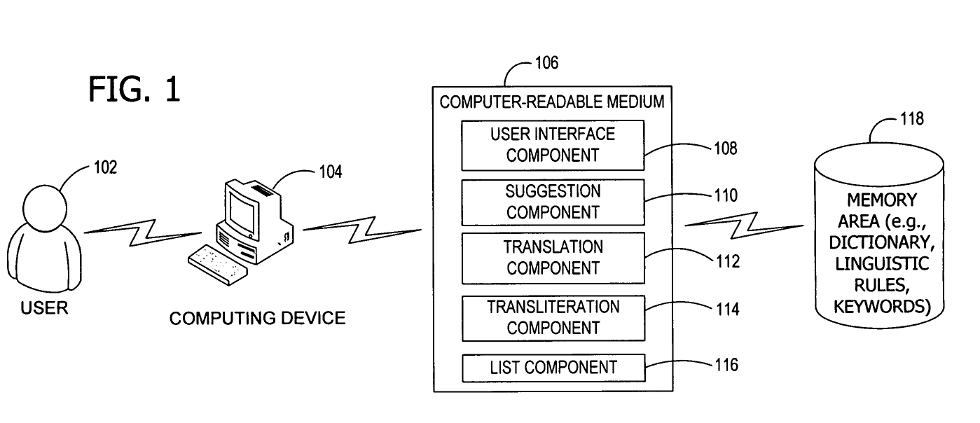

In an embodiment, the invention provides cross-language suggestion of related keywords. FIG. 1 illustrates a suitable operating environment in which aspects of the invention may be implemented. A user 102 interfaces with a computing device 104 that accesses one or more computer-readable media such as computer-readable medium 106 to identify keywords related to an input keyword. The computer-readable media have one or more computer-executable components for cross-language keyword selection. In operation, the computing device 104 executes computer-executable components such as those illustrated in the figures to implement aspects of the invention. For example, the computer-readable medium 106 includes an interface component 108, a suggestion component 110, a translation component 112, a transliteration component 114, and a list component 116. The interface component 108 receives an input keyword in a first language from the user 102. The suggestion component 110 identifies keywords in the first language related to the input keyword received by the interface component 108. The translation component 112 identifies translation candidates in a second language as a function of the input keyword received by the interface component 108 and the related keywords identified by the suggestion component 110. The suggestion component 110 further identifies keywords in the second language related to the translation candidates. In one embodiment, the list component 116 ranks the translation candidates identified by the translation component 112. The interface component 108 presents the identified translation candidates, the related keywords in the first language, and the related keywords in the second language to the user 102 for selection. In one embodiment, the transliteration component 114 maps the input keyword received by the interface component 108 to a keyword in the second language, for example, to account for linguistic differences between the first language and the second language. Each of the components 108, 110, 112, 114, 116 may access a memory area 118 storing one or more dictionaries, keywords, linguistic rules, etc.

The process and system illustrated in FIG. 1 enable the user 102 (e.g., an advertiser of goods or services) to target particular markets or to target users (e.g., customers) fluent in various languages. For instance, if the user 102 types in “encyclopedia” and indicates a desire to obtain related keywords in French, aspects of the invention provide keywords such as “encyclopédie” or “dictionnaire Encarta.” While aspects of the invention are demonstrated by English-French translation in some examples herein, these aspects are applicable to any other pair of language translation.

The exemplary operating environment illustrated in FIG. 1 includes a general purpose computing device (e.g., computing device 104) such as a computer executing computer-executable instructions. The computing device typically has at least some form of computer readable media (e.g., computer-readable medium 106). Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. A user may enter commands and information into the computing device through input devices or user interface selection devices such as a keyboard and a pointing device (e.g., a mouse, trackball, pen, or touch pad). Other input devices (not shown) may be connected to the computing device. The computing device may operate in a networked environment using logical connections to one or more remote computers.

Although described in connection with an exemplary computing system environment, aspects of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

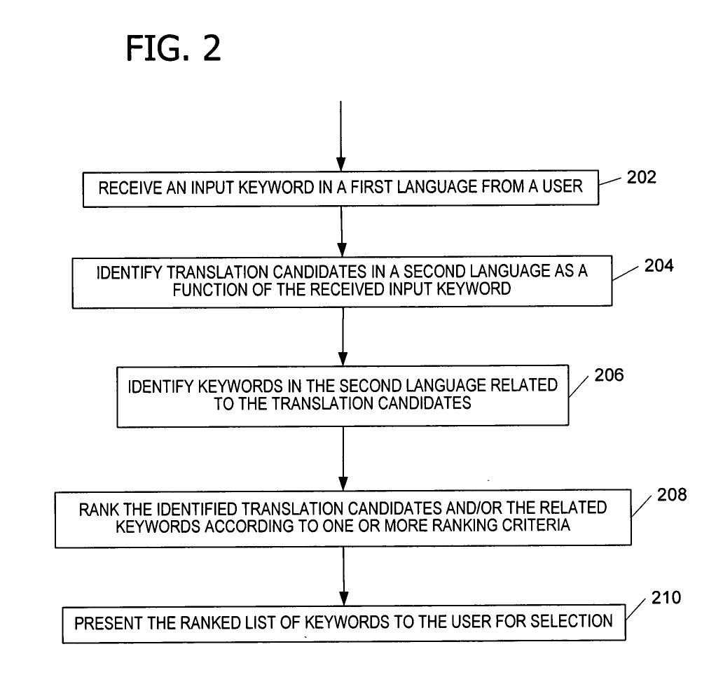

Referring next to FIG. 2, an exemplary flow chart illustrates operation of the components illustrated in FIG. 1. The computerized method of multilingual keyword identification receives an input keyword in a first language from a user at 202 and identifies translation candidates in a second language as a function of the received input keyword at 204. For example, the translation candidates may be identified by direct translation of the received input keyword and/or transliteration of the received input keyword to account for linguistic differences between the first and second languages. Aspects of the invention are operable with any typical form and method of direct translation and transliteration. In one example, transliteration includes segmenting a word (e.g., into syllables) and then converting each segment into a character in the target (e.g., second) language. With transliteration, for example, video can be changed to video and ligne can be changed to line. Transliteration rules may differ with each pair of original (e.g., first) and target (e.g., second) languages. After transliteration, the method may validate the transliterated keyword because some transliterated results may not be valid words in the second language. Validating the transliterated input keyword may include identifying the transliterated input keyword in a dictionary or validating with web search results. If the transliterated input keyword exists in the dictionary, then that keyword is valid. If the transliterated keyword does not exist in the dictionary, then a web search may be performed on the transliterated keyword. If the search engine does not return a significant number of results, then the transliterated keyword is not valid and hence not included as a translation candidate. In another embodiment, morphological changes such as stemming may be applied to the received input keyword to generate a list of keyword variations (e.g., identify a root form of the keyword). The translation candidates may be identified as a function of this generated list of keyword variations. Those skilled in the art are familiar with the morphological analysis of words.

The method illustrated in FIG. 2 further identifies keywords in the second language related to the translation candidates at 206 (e.g., via a typical unilingual keyword suggestion application program) and ranks the identified translation candidates and/or the related keywords according to one or more ranking criteria at 208 to produce a list of keywords in the second language for selection by the user. For example, a maximum entropy (ME) model may be employed to rank the translation candidates and, in one embodiment, the related keywords generated by the keyword suggestion application. The ranking criteria include, but are not limited to, one or more of the following: a number of web pages containing each of the translation candidates, transliteration similarities between the input keyword and the translation candidates, and contextual similarities between the input keyword and the translation candidates. The actual form and features of the ME model, however, are language specific. Those skilled in the art are familiar with the ME model. An exemplary ME model is described in Appendix A.

In one alternative embodiment, a click-through model is used to rank the translation candidates. For example, the translation candidates are ranked based on how many people selected each of the translation candidates. Another alternative to the ME model includes linear interpolation of the ranking criteria (e.g., linear regression and machine leaming).

The list of keywords is presented to the user for selection at 210. That is, the original input keyword is displayed, the related keywords in the original (e.g., first) language are displayed, and the related keywords in the target (e.g., second) language are displayed. In one alternative embodiment, the method selects one or more of the keywords for the user and presents the selected keywords. For example, the method may present the top five keywords in the ranking.

In another embodiment, the method identifies and presents keywords in the first language related to the input keyword to expand the list of translation candidates. In such an embodiment, there is no one-to-one mapping between the related keywords in the first language and the related keywords in the second language. These related keywords may be stored in unilingual related keyword tables. The related keywords in the first language may be determined or identified before, during, or after identifying the translation candidates. Determining related keywords in both the first and second languages (e.g., generating keyword clusters) improves the results of the method because there may not be a direct translation for the input keyword or a determined, related keyword in the first language (e.g., as determined by generating a keyword cluster in the first language). With the knowledge that one keyword whose context is known is related to another keyword, the context of the other keyword may be inferred. For example, with “voiture de luxe” as the input keyword and “Porsche” as a keyword determined to be related to the input keyword, the method translates “voiture de luxe” into “luxury car” but fails to directly translate “Porsche.” However, by combining the two unilingual related keyword tables, the method infers that “Porsche” is related to “luxury car.”

In one embodiment, one or more computer-readable media have computer-executable instructions for performing the method illustrated in FIG. 2.

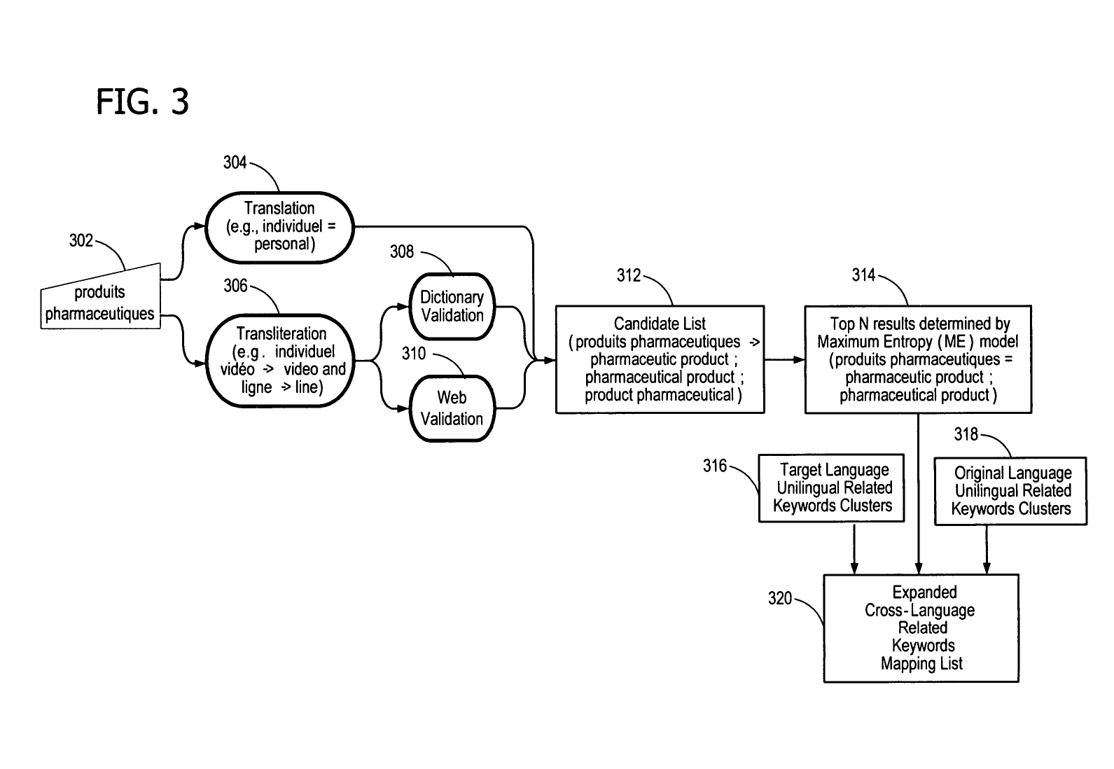

Referring next to FIG. 3, an exemplary flow chart illustrates cross-language related keyword suggestion with French as the original language and English as the target language. In this example, the input keyword is “produits pharmaceutiques” at 302. The user desires to view a list of keywords in English that correspond to this French term. Direct translation and transliteration occur at 304 and 306, respectively. The transliterated results are validated using a dictionary at 308 and using the web at 310. Aspects of the invention are operable with other validation sources such as intranet web pages, a document repository, news feeds, or other searchable content in the target language. The translation results and the validated transliteration results comprise the translation candidate list (in English) at 312. In this example, the list includes the following: pharmaceutic product, pharmaceutical product, and product pharmaceutical.

These results are then ranked (e.g., by an ME model) at 314 and the top results are determined. In this example, the term “product pharmaceutical” was ranked the lowest among the translation candidates and removed from the list. Keyword clusters are generated for the input French keyword at 318 and the English translation candidates at 316. The top translation candidates from 314, the French keyword cluster from 318, and the English keyword cluster from 316 are presented to the user as an expanded cross-language related keywords mapping list. From this list, the user may select particular keywords (in English) to use to promote a good or service associated with the input keyword.

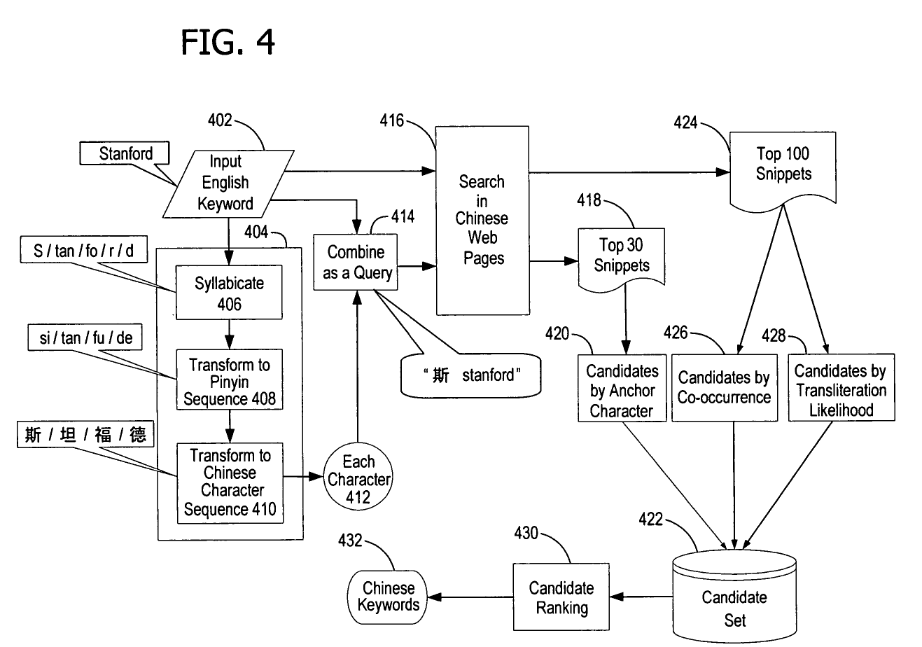

Referring next to FIG. 4, an exemplary flow chart illustrates keyword transliteration and validation using web search results. In this example, Chinese keywords are being identified from an English keyword “Stanford” input at 402. Transliteration occurs at 404 as the input English keyword is syllabicated at 406, transformed to a Pinyin sequence at 408, and transformed to a Chinese character sequence at 410. The results of each operation are shown in FIG. 4. Each Chinese character resulting from the transliteration at 412 is combined with the input English word into a combined query at 414 for a search of Chinese web pages at 416. In this example, the top 30 snippets from the web search 418 are organized by anchor character at 420 for inclusion in the translation candidate set 422. Also in this example, the top 100 snippets 424 are determined from a web search 416 of the input English keyword at 402 and each of the combined queries from 414. From the top 100 snippets 424, candidates by co-occurrence and candidates by transliteration likelihood are identified at 426 and 428, respectively, and included in the translation candidate set 422. The translation candidate set 422 is ranked at 430 and presented to the user as the Chinese keywords 432 relating to the input English keyword.

An alternative procedure for identifying, ranking, and selecting keywords using web mining is shown in Appendix B. An example of the alternative procedure is also included in Appendix B.

Hardware, software, firmware, computer-executable components, computer-executable instructions, and/or the contents of FIGS. 1-4 constitute means for identifying translation candidates in a second language as a function of an input keyword in a first language, means for identifying keywords in the first language related to the input keyword and for identifying keywords in the second language related to the translation candidates, means for ranking the translation candidates according to one or more ranking criteria, means for generating a keyword mapping list of the ranked translation candidates, the related keywords in the first language, and the related keywords in the second language, and means for selecting keywords from the generated keyword mapping list. In one embodiment, means for selecting keywords includes means for presenting keywords to the user for selection.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

A maximum entropy (ME) model may be used in one embodiment to rank the translation candidates. The ME model ranks the translation candidates with the following features.
1. The Chi-Square of translation candidate C and the input English named entity E is shown in (1) below.

$${S}_{cs} ( C , E ) = \frac{N \times {( a \times d - b \times c )}^{2}}{( a + b ) \times ( a + c ) \times ( b + d ) \times ( c + d )} \qquad ( 1 )$$

where:

a=the number of web pages containing both C and E

b=the number of web pages containing C but not E

c=the number of web pages containing E but not C

d=the number of web pages containing neither C nor E

N=the total number of web pages, i.e., N=a+b+c+d

In this example, N is set to 4 billion, but the value of N does not affect the ranking once it is positive. The model combines C and E as a query to search a search engine for Chinese web pages. And the result page contains the total page number containing both C and E which is a. Then C and E are used as queries respectively to search the web to get the page numbers Nc and Ne. So b=Nc−a and c=Ne−a and d=N−a−b−c.
2. Contextual feature Scƒ1(C,E)=1 if in any of the snippets selected, E is in a bracket and follows C or C is in a bracket and follows E.
3. Contextual feature Scƒ2(C,E)=1 if in any of the snippets selected, E is second to C or C is second to E.
4. Similarity of C and E in terms of transliteration score (TL) is shown in (2) below.

$$TL ( C , E ) = \frac{L ( Pe ) - ED ( Pe , PYc )}{L ( Pe )} \qquad ( 2 )$$

Pe is the transliterated Pinyin sequence of E, and PYc is the Pinyin sequence of C. L(Pe) is the length of Pe, and ED(Pe,PYc) is the edit distance between Pe and PYc. With these features, the ME model is expressed as shown in (3) below.

$$P ( C \text{\vert} E ) = {p}_{{Z}_{1}^{′}} ( C \text{\vert} E ) = \frac{exp [ {\sum }_{m = 1}^{M} {λ}_{m} {h}_{m} ( C , E ) ]}{{\sum }_{{C}^{′}} exp [ {\sum }_{m = 1}^{M} {λ}_{m} {h}_{m} ( C , E ) ]} \qquad ( 3 )$$

where C denotes Chinese candidate, E denotes English NE, and m is the number of features.

### Appendix B

The process of ranking the translation candidates obtained from the dictionary or other source and selecting the translation candidates from this ranking through web mining is shown below. The process includes the following operations.

A. Format the query translation candidates obtained from the dictionary using a Boolean query.

B. Limit the search region using the source query otherwise the search engine returns only the most popular term combinations.

C. Search the structure query in a web search engine and set the returned result language type as the original language. Get the top 100 snippets from the search results.

D. Use an algorithm to analyze the top 100 snippets and get the top 50 term phrases sorted by phrase frequency.

E. Filter the term phrase and keep the phrase that contains exact one word for each word in the target language query.

F. If there is at least one phrase after filtering go to operation G, else go to operation H.

G. Get the translation candidates and terminate.

H. Enumerate all the possible combinations of translation candidates and re-format the query as (a) target language query+one candidate and (b) “+candidate+” for every candidates of the combinations.

I. Search the two queries for each candidate in a web search engine and get the count number returned by the search engine. J. Rank the candidates according to the combination of its two count number for each candidate.
Alpha*Count(a)+(1−Alpha)*Count(b) . . . (1)

(Alpha=0.6, for example)

K. Return the top five translation candidates as the final result.

The following example illustrates the above exemplary procedure. In this example, the original language is French and the target language is English. The French query is “pages jaunes” and translation candidates from a dictionary include “page;hansard/yellow;yolk”. The Boolean query in operation A above is ((Page OR hansard) AND (yellow OR yolk)). The query from operation B above includes ‘“pages jaunes”+((Page OR hansard) AND (yellow OR yolk))’. After searching the structure query in a web search engine, retrieving the top 100 snippets from the search results, and using an algorithm to obtain the top 50 term phrases, the following phrases are obtained in this example: main page; yellow pages; yellow page; home page; blank page; white page. The translation result returned to the user is “yellow pages; yellow page”.

In another example, the French query may be “fermer cette liste” and the translation candidates include “close; closing; shut; fasten/this; it; these; those/list; roll; register”. The Boolean Query is ((close OR closing OR shut OR fasten)AND(this OR it OR these OR those)AND(list OR roll OR register)). With the algorithm in operation D above, there is no result after filtering in operation F. In operation H, the translation candidates are enumerated to include the following: close this list, close it list, close these list, close those list, closing this list, closing it list, close these list, etc. The query is re-formatted as “fermer cette liste+close this list” and “close this list”. An exemplary count for “fermer cette liste+close this list” is 688 and an exemplary count for “close this list” is 1390. The two counts are combined and the candidates are ranked in operation J above.

What is claimed is:

1. A computerized method of multilingual keyword identification, said computerized method comprising:
receiving an input keyword in a first language from a user;
identifying translation candidates in a second language as a function of the received input keyword;
identifying keywords in the second language related to the translation candidates; and
ranking the identified translation candidates and the related keywords according to one or more ranking criteria to produce a list of keywords in the second language for selection by the user.

2. The computerized method of claim 1, further comprising presenting the list of keywords to the user for selection.

3. The computerized method of claim 1, further comprising selecting one or more keywords from the list of keywords and presenting the selected keywords to the user.

4. The computerized method of claim 1, wherein ranking the identified translation candidates and the related keywords comprises ranking the identified translation candidates and the related keywords to produce the list of keywords in the second language for selection by a user for keyword-based advertising or keyword suggestion.

5. The computerized method of claim 1, wherein identifying the translation candidates in the second language comprises translating the received input keyword.

6. The computerized method of claim 1, wherein identifying the translation candidates in the second language comprises:
transliterating the received input keyword; and
validating the transliterated input keyword.

7. The computerized method of claim 6, wherein validating the transliterated input keyword comprises validating the transliterated input keyword by identifying the transliterated input keyword in a dictionary.

8. The computerized method of claim 6, wherein validating the transliterated input keyword comprises validating the transliterated input keyword with web search results.

9. The computerized method of claim 1, wherein identifying the translation candidates in the second language comprises morphologically analyzing the received input keyword to generate a list of keyword variations, and wherein identifying the translation candidates in the second language comprises identifying the translation candidates in the second language as a function of the generated list of keyword variations.

10. The computerized method of claim 1, wherein ranking the identified translation candidates and the related keywords according to one or more ranking criteria comprises ranking the identified translation candidates and the related keywords with a maximum entropy (ME) model.

11. The computerized method of claim 1, wherein ranking the identified translation candidates and the related keywords according to one or more ranking criteria comprises ranking the identified translation candidates and the related keywords according to one or more of the following ranking criteria: a number of web pages containing each of the translation candidates, transliteration similarities between the input keyword and the translation candidates, and contextual similarities between the input keyword and the translation candidates.

12. The computerized method of claim 1, further comprising identifying keywords in the first language related to the input keyword, wherein there is no one-to-one mapping between the related keywords in the first language and the related keywords in the second language.

13. The computerized method of claim 1, wherein one or more computer-readable media have computer-executable instructions for performing the computerized method of claim 1.

14. One or more computer-readable media having computer-executable components for cross-language keyword selection, said components comprising:
an interface component for receiving an input keyword in a first language from a user;
a suggestion component for identifying keywords in the first language related to the input keyword received by the interface component;
a translation component for identifying translation candidates in a second language as a function of the input keyword received by the interface component and the related keywords identified by the suggestion component, wherein the suggestion component further identifies keywords in the second language related to the translation candidates, and wherein the interface component further presents the identified translation candidates, the related keywords in the first language, and the related keywords in the second language to the user for selection.

15. The computer-readable media of claim 14, further comprising a transliteration component for mapping the input keyword received by the interface component to a keyword in the second language.

16. The computer-readable media of claim 14, further comprising a list component for ranking the translation candidates identified by the translation component.

17. The computer-readable media of claim 14, wherein the translation component validates the keywords in the first language identified by the suggestion component.

18. A cross-language keyword suggestion system comprising:
means for identifying translation candidates in a second language as a function of an input keyword in a first language;
means for identifying keywords in the first language related to the input keyword and for identifying keywords in the second language related to the translation candidates;
means for ranking the translation candidates according to one or more ranking criteria;
means for generating a keyword mapping list of the ranked translation candidates, the related keywords in the first language, and the related keywords in the second language; and
means for selecting keywords from the generated keyword mapping list.

19. The cross-language keyword suggestion system of claim 18, wherein means for selecting keywords comprises means for presenting keywords to the user for selection.

20. The cross-language keyword suggestion system of claim 18, wherein means for identifying keywords in the first language related to the input keyword and for identifying keywords in the second language related to the translation candidates comprises a unilingual keyword suggestion tool.
